(19) United States
(12) Patent Application Publication
(10) Pub. No.: US 2022/0274618 A1
(43) Pub. Date: Sep. 1, 2022

(54) METHOD FOR MANAGING THE KILOMETER RANGE OF A VEHICLE

(71) Applicant: RENAULT s.a.s., Boulogne-Billancourt (FR)

(72) Inventors: Nicolas CHARR, Paris (FR); Marco MARSILIA, Cachan (FR)

(73) Assignee: RENAULT s.a.s., Boulogne-Billancourt (FR)

(21) Appl. No.: 17/632,395

(22) PCT Filed: Jul. 2, 2020
(86) PCT No.: PCT/EP2020/068630

§ 371 Date: Feb. 2, 2022

(30) Foreign Application Priority Data
Aug. 9, 2019 (FR) 1909106

(51) Int. Cl. B60W 50/14; B60K 35/00; B60L 58/13

(52) U.S. Cl. CPC B60W 50/14; B60K 35/00; B60L 58/13; B60W 2050/146; B60W 2510/244; B60W 2556/10; B60K 2370/169; B60L 2250/16; B60L 2260/52

(57) ABSTRACT

A method manages a kilometer range of an electric-traction vehicle supplied with power by an electric battery including a usable capacity and a reserve. When the vehicle indicates a remaining range that is equal to a number of guaranteed kilometers, the method displays a range that decreases linearly over time, regardless of the coming driving conditions for the vehicle.

The invention relates to a method for managing the kilometer range of a vehicle. A method according to the invention applies in particular to any electric traction vehicle powered by an electric traction battery.

The kilometer range of an electric traction vehicle is a parameter that should be well-controlled, as otherwise there is a risk of seriously letting the customer down. Specifically, a poor estimate of this range can lead to the vehicle coming to a standstill due to lack of electric power, and result in the customer having to call out a recovery truck to tow their vehicle to a charging point.

An estimate of the remaining kilometer range of an electric vehicle is generally displayed on the dashboard, in order to inform the driver as to the number of kilometers that they can still expect to travel with their vehicle. Now, the driver often tends to consider this information as an absolute truth. However, such a displayed range is often only an estimate giving an approximate idea of the number of kilometers that the vehicle can still travel, as this number depends on several factors that are variable by nature: past and future driving style, road type, vehicle mass, climate conditions, etc.

The amount of energy stored in a battery is often expressed as a percentage of its storage capacity. Hereafter in this document, this percentage information will be referred to as the SOC (for “state of charge”). The SOC of a fully charged battery is thus 100%, and that of an empty battery is 0%.

The SOC and the stated range are therefore the indicators most used by the driver to manage their electric vehicle. The importance of the estimate of the SOC and of the range is much greater when the battery has a low charge, as the customer relies on these indicators when deciding whether to continue driving or to stop and charge their vehicle. It is therefore important that the customer can trust in the range that is stated, so as not to find themself stranded due to an inaccurate estimate.

Application FR3018480 discloses a method that aims to limit the “variability” in the range displayed to the driver, this range being dependent on the driving conditions in general, which are highly variable. For this, the stored energy is first separated into a “nominal” amount and a “reserve” amount. Next, the actual instantaneous consumption is estimated. Finally, the remaining range of the vehicle is calculated, either from the nominal amount only if the consumed energy is less than a predefined threshold, or from the nominal amount and the reserve amount if the consumed energy is greater than the threshold.

In this application it can be seen that, by using the reserve amount of energy gradually and under certain conditions, the estimated and displayed range is thus almost constant regardless of the conditions of use of the vehicle. In addition, the existence of this reserve amount is completely unknown to the driver, who never knows that the displayed range optionally uses a reserve amount in order to compensate for adverse driving conditions.

The main drawback of the method according to FR3018480 is that, since the latter is implemented over the entire SOC range (100% to 0%) while the reserve amount is quite limited, it is necessary to set the threshold for taking the reserve into account at a very high value, to avoid taking the reserve into account too early and too often to estimate the remaining range, and thus to ensure that the method is effective for as long as possible. In other words, the method can make it possible to overcome a limited number of high overconsumption peaks, not more, and it then risks becoming less effective. In particular, it risks being less effective at the end of the SOC range (approaching 0%), even for low overconsumption, whereas it is then when it is most anxiety-provoking.

A method for managing the kilometer range of an electrically driven vehicle according to the invention makes it possible to display, in the vehicle at the end of the SOC range, a remaining kilometer range that varies intuitively regardless of the driving conditions of the vehicle, this displayed range optionally being able to take into account a reserve energy capacity of said battery. Hereafter in the present application, this reserve energy capacity will simply be referred to as the “reserve”.

The subject of the invention is a method for managing the kilometer range of an electric traction vehicle powered by an electric battery comprising a working capacity and a reserve.

According to the invention, the method comprises, as soon as the remaining kilometer range of the vehicle is equal to or less than a minimum number of guaranteed kilometers (Km_guaranteed), a final step of displaying a range that decreases linearly over time, regardless of the driving conditions of the vehicle.

In order to remove any ambiguity, the working capacity and the reserve are two distinct portions of the battery, the working capacity corresponding to the capacity of the battery for which a user has purchased said battery, and the reserve remaining hidden from said user.

A method according to the invention therefore applies to a vehicle having an electric battery comprising a working capacity and a reserve, and aims to reassure a driver that the last few kilometers corresponding to the displayed kilometer range will actually be able to be traveled by the vehicle, regardless of the future driving conditions of the vehicle. A method according to the invention is triggered from a minimum threshold state of charge taking into account the working capacity of the battery. As soon as this threshold minimum state of charge is reached, an on-board computer displays a remaining range which is dependent on the previous driving conditions of the vehicle, and which will intuitively vary with time, i.e. by decreasing linearly with time, regardless of the future driving conditions of the vehicle.

Two cases may then arise:

If the future driving conditions of the vehicle are identical to or even less harsh than the previous driving conditions, the linear decrease of the displayed remaining range will be ensured solely by the working capacity of the battery.

If the future driving conditions of the vehicle are harsher than the previous driving conditions, the linear decrease of the displayed remaining range will be ensured by both the working capacity of the battery and the reserve of said battery.

A method according to the invention does not systematically call upon the reserve of the electric battery to ensure the linear decrease of the remaining range of the battery, but only when necessary. In the context of a method according to the invention, the reserve is only used in some particular cases to ensure a linear decrease of the remaining electric range, and thus to reassure a driver who knows that their vehicle will be able to travel the distance that will be given by the displayed remaining kilometer range.

According to one possible feature of the invention, the kilometer range of the vehicle before it reaches the minimum number of guaranteed kilometers is determined from the state of charge of the battery by taking into account the working capacity of the battery but not the reserve, and taking into account the previous driving conditions of the vehicle.

According to one possible feature of the invention, the final display step comprises, if the current driving conditions of the vehicle are more demanding than the previous driving conditions, taking into account the working capacity and the reserve to ensure that the displayed range decreases linearly. Specifically, the electric range of the vehicle is produced on the basis of the state of charge taking into account the working capacity of the battery and on the basis of the previous driving conditions of the vehicle. Therefore, if the current driving conditions of the vehicle were more demanding than the previous driving conditions, just the working capacity of the battery would likely not be sufficient to ensure a linear decrease of the displayed remaining range, and it would then be necessary to call upon than the reserve of the battery.

According to one possible feature of the invention, the method receives as input the following values:

USOC_battery_not_filtered corresponding to the actual physical state of charge level of the battery, expressed as a percentage of its capacity, and taking into account the working capacity and the reserve,

Margin_battery_inf corresponding to the energy reserve and equal to the difference between the working capacity and the actual capacity of the battery, expressed as a percentage of its capacity,

Range_km corresponding to the range stated to the customer on the dashboard, expressed in kilometers,

Distance_km corresponding to the distance traveled by the vehicle, expressed in kilometers,

Km_guaranteed corresponding to the minimum number of guaranteed kilometers.

According to one possible feature of the invention, the method comprises calculating the state of charge over the nominal working range of the restricted battery (USOC_filtered_range_nominal) using the formula:

$$USOC\_filtered \_range \_nominal = Max ( 0 : \frac{USOC\_battery \_not \_filtered - margin\_battery \_inf}{100 - margin\_battery \_inf} * 100 )$$

The restricted battery corresponds to the working or nominal capacity of said battery, without reserve.

According to one possible feature of the invention, the method comprises a prior step of displaying the state of charge over the nominal working range of the restricted battery as long as the stated range (Range_km) is greater than the minimum number of guaranteed kilometers (Km_guaranteed).

According to one possible feature of the invention, the final display step comprises calculating a virtual state of charge (USOC_xxkm), which decreases linearly with the distance traveled from when the stated range is equal to or less than the minimum number of guaranteed kilometers (Km_guaranteed).

According to one possible feature of the invention, the final display step comprises displaying a final state of charge (USOC_filtered_customer) given by the formula:

USOC_filtered _customer=Max (USOC_filtered_range_nominal, Min (USOC_xxkm, USOC_battery_not_filtered))

This formula makes it possible to ensure that the SOC is modified by the strategy that guarantees the last few km only when the driver is “overconsuming” with respect to their previous consumption considered in the calculation for the displayed range. This makes it possible to guarantee the driver the stated last few km, and therefore to allow them to avoid unexpected breakdowns, which will be troublesome to manage.

A management method according to the invention allows the vehicle to dependably and reliably ensure the last few kilometers displayed when estimating the kilometer range of the vehicle, and to do so despite harsher driving conditions that tend to increase electricity consumption. A management method according to the invention has the advantage of being implemented without requiring modifications to the vehicle and to the battery, and without having to add additional parts which are a source of cost and bulk.

A detailed description of one preferred embodiment of a management method according to the invention is given hereinafter, with reference to the following figures:

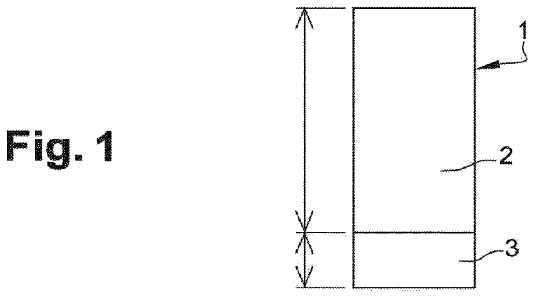

FIG. 1 is a schematic view of an electric battery of a vehicle from which a management method according to the invention is carried out,

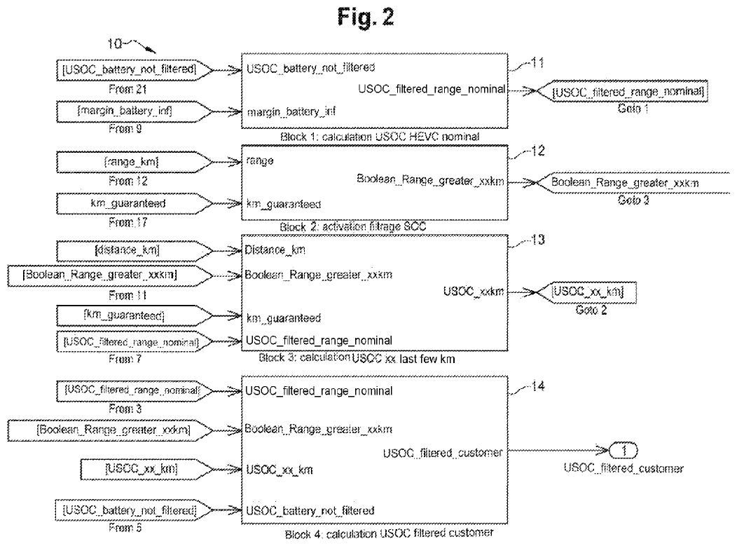

FIG. 2 is a general flowchart illustrating the various steps of a management method according to the invention,

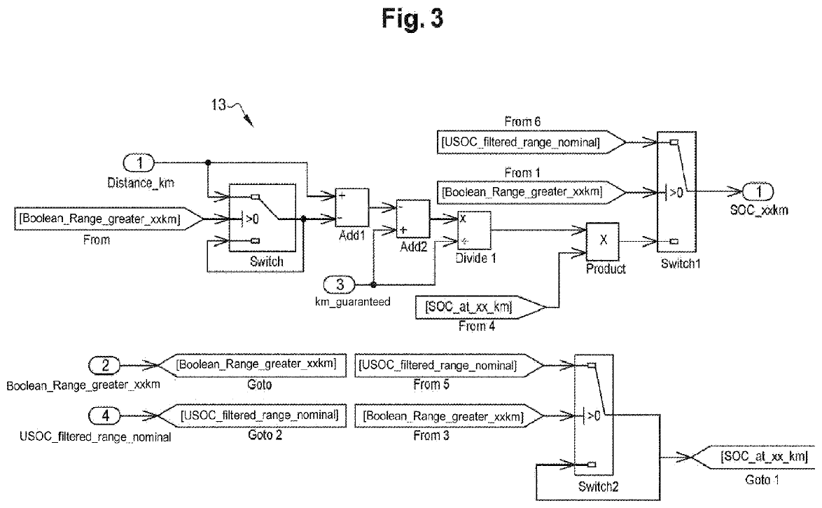

FIG. 3 is a flowchart illustrating the operation of the third block of the software for driving a management method according to the invention,

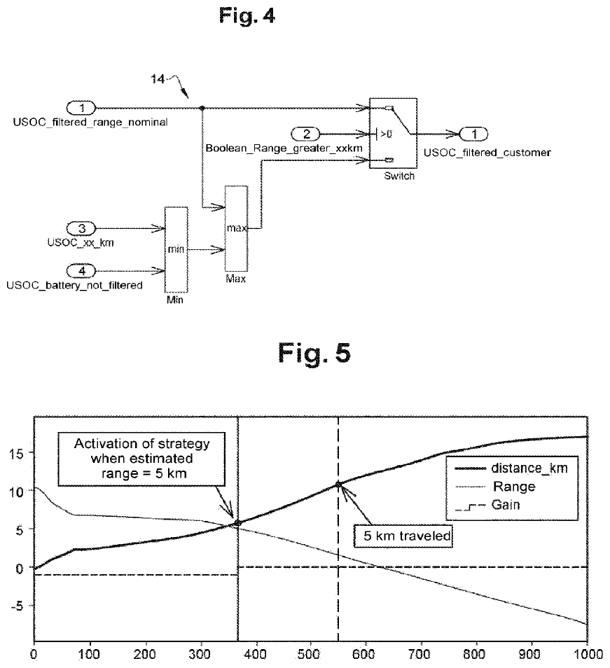

FIG. 4 is a flowchart illustrating the operation of the fourth block of the software for driving a management method according to the invention,

FIG. 5 is a diagram over time for comparing an estimated range with a distance actually traveled by the vehicle when a management method according to the invention is activated, in the event of an increase in power consumption in the last few kilometers,

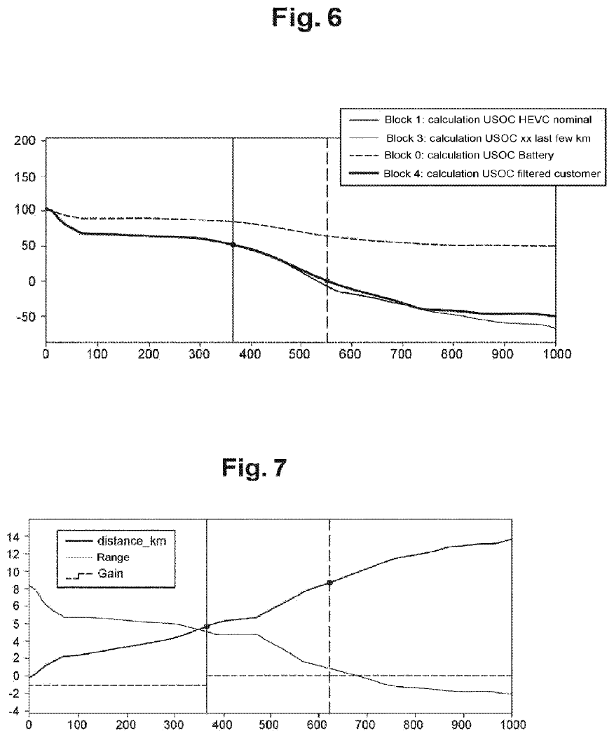

FIG. 6 is a diagram over time for comparing the various SOCs in the case of the example illustrated in FIG. 5,

FIG. 7 is a diagram over time for comparing an estimated range with a distance actually traveled by the vehicle when a management method according to the invention is activated, in the event of a decrease in power consumption in the last few kilometers,

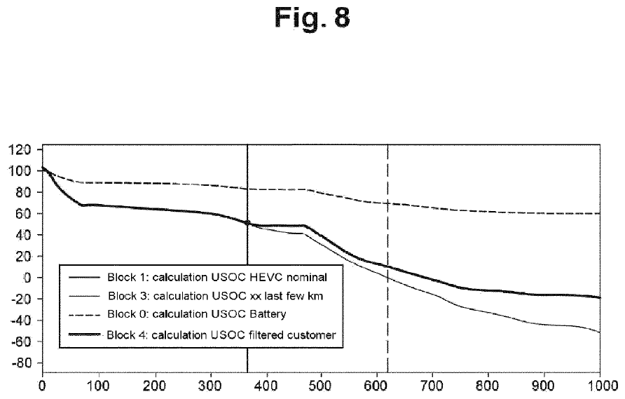

FIG. 8 shows a diagram over time for comparing the various SOCs in the case of the example illustrated in FIG. 7.

The term SOC represents a state of charge.

Referring to FIG. 1, a method for managing the kilometer range of a vehicle according to the invention is applicable to an electric traction vehicle powered by an electric battery 1, comprising a working capacity 2 and a reserve 3, said reserve 3 preferably representing between 5% and 30% of the actual total capacity (working capacity+reserve) of said battery 1. This method can be applied in any case where the nominal working range of the battery is reduced with respect to the actual capacity. This restriction results in a usable energy margin (reserve) located below the customer's nominal working range and thus 0% SOC.

A number of examples of electric vehicles are present on the market which include a battery 1 that has a physical capacity greater than the nominal capacity. Specifically, in the case of a multiple battery (small/large capacity) offering, it may be more economical for a vehicle manufacturer to produce only a single physical object, in order to avoid a larger number of parts while still providing a varied offering in terms of range. A method according to the invention makes it possible to provide an additional benefit in the vehicle, by intelligently exploiting this additional energy margin (reserve) without additional investment on the part of the manufacturer.

A management method according to the invention comprises, when the vehicle indicates a remaining range equal to a very low and predetermined threshold value, a step of displaying a range that decreases linearly over time, regardless of the future driving conditions of the vehicle.

In other words, the prediction of the kilometer range of the vehicle is made only on the basis of the working capacity 2 of the battery 1, and more precisely on the state of charge taking into account said working capacity 2, and the driving history of the vehicle over the kilometers already traveled. The reserve 3 of the battery 1 is not involved in the prediction of this kilometer range. Thus, when the displayed kilometer range indicates to the driver that the vehicle is now only able to travel a few more kilometers, it is important for said driver to be certain that their vehicle will be able to travel them, regardless of the future driving conditions of their vehicle, without having the bad surprise of experiencing their vehicle being immobilized at the roadside, due to lack of electric power. Such a method is triggered when the state of charge of the working capacity 2 of the battery 1 reaches a minimum threshold value. Once this threshold value is reached, an on-board computer calculates the remaining kilometer range based on the previous driving conditions of the vehicle, and then displays a remaining kilometer range that is intuitive for the driver, that is to say that decreases linearly with time. Two cases may then arise:

If the future driving conditions of the vehicle are identical to or less harsh than the previous driving conditions, the linear decrease of the displayed remaining range will be ensured solely by the working capacity 2 of the battery 1.

If the future driving conditions of the vehicle are more demanding than the previous driving conditions, the linear decrease of the displayed remaining range will be ensured by both the working capacity of the battery and the reserve of said battery.

Driving conditions likely to increase power consumption are to be chosen from among an increased speed of the vehicle, an increased engine speed, a sloping road relief, the climate conditions and an aggressive driving style on the driver's part. The conditions listed above may be considered individually or in combination. They are illustrative and non-limiting examples of adverse conditions that are likely to increase the power consumption of the vehicle.

Referring to FIG. 2, a management method according to the invention is driven by means of software comprising inputs 10, a first block 11, a second block 12, a third block 13 and a fourth block 14.

The inputs 10 are as follows:

USOC_battery_not_filtered [%]: This signal indicates the actual physical state of charge level of the battery, expressed as a percentage of its capacity,

Margin_battery_inf [%]: Energy margin corresponding to the difference between the working capacity and actual capacity of the battery,

Range_km [km]: Range stated to the customer, on the dashboard,

Distance_km [km]: Distance traveled by the vehicle,

Km_guaranteed: this parameter makes it possible to choose the number of kilometers that it is desired to guarantee with the strategy.

The parameter for setting the strategy is Km_guaranteed [km]. This parameter makes it possible to choose the number of kilometers that it is desired to guarantee with the strategy.

The first block 11 calculates the SOC over the nominal working range of the restricted battery 1. This signal, which will be called “USOC_filtered_range_nominal”, is displayed to the customer as long as the stated range Range_km is greater than the number of “guaranteed” km Km_guaranteed.

The signal USOC_filtered_range_nominal is obtained using the following equation:

$$USOC\_filtered \_range \_nominal = Max ( 0 : \frac{USOC\_battery \_not \_filtered - margin\_battery \_inf}{100 - margin\_battery \_inf} * 100 )$$

The second block 12 produces a Boolean that compares the stated range with respect to the last few kilometers guaranteed by the strategy.

The output of this block is the Boolean which is given by the formula:

$$Boolean\_Range \_greater \_xxkm = \{ \begin{matrix}1 & if range\_km > km\_guaranteed \\ 0 & otherwise\end{matrix}$$

Referring to FIG. 3, the third block 13 defines a new virtual SOC signal called USOC_xxkm which decreases linearly with the distance traveled from when the stated range passes below the threshold, km_guaranteed, which corresponds to the number of guaranteed km. The output signal USOC_xxkm therefore reaches the value 0% when the last few km km_guaranteed have actually been traveled by the car.

The logic for producing the third block 13 is shown in FIG. 3 in which, to recall:

Distance_km [km]: Distance actually traveled by the vehicle,

Km_guaranteed [km]: Parameter for setting the strategy which corresponds to the number of kilometers guaranteed by the strategy (it is possible, for example, to select a value of 5 km for this parameter),

USOC_filtered_range_nominal: the SOC of the battery 1 calculated over the nominal range 2 of the restricted battery (output of the first block 11).

When the estimated range passes below km_guaranteed (km), the block 13 calculates an SOC that decreases linearly with the traveled distance so that, at the end of km_guaranteed (km), the calculated value reaches 0. When the range is greater than km_guaranteed (km), the output of this block 13 is the SOC of the nominal range of the restricted battery 2 USOC_filtered_range_nominal calculated by the first block 11.

Referring to FIG. 4, the fourth block 14 calculates the final SOC that will be displayed to the customer on the dashboard of the car. The objective of this block 14 is to modify the SOC calculated by the first block 11 over the restricted nominal range only when necessary. That is to say, when the latter will reach 0% before the driver has been able to travel the last few km km_guaranteed that had been stated to them. To do this, when the range passes below the km_guaranteed km threshold, the SOC of the nominal range USOC_filtered_range_nominal is continuously compared with the virtual SOC USOC_xxkm constructed over the last few kilometers by the third block 13 in order to state to the customer the max between these two values and with saturation by the actual SOC of the battery 1 in order to ensure that it never departs from the physical range of the battery. The SOC finally displayed to the customer is therefore:

### SOC_filtered_customer=Max (USOC_filtered_range_nominal, Min (USOC_xxkm, USOC_battery_not_filtered))

This formula makes it possible to ensure that the SOC is modified by the strategy that guarantees the last few km only when the driver is “overconsuming” with respect to their previous consumption considered in the calculation for the displayed range. This therefore makes it possible to guarantee them the stated last few km, and therefore for them to avoid untimely and unexpected breakdowns, which will result in customer discontent, even in the case of dramatic changes in driving style or consumption.

Specifically, if the driver reduces their consumption over the last few guaranteed kilometers by virtue, in particular, of regenerative phases that allow the battery to be charged and the restricted SOC (USOC_filtered_range_nominal) to be returned above the calculated value in order to guarantee the last few km (USOC_xxkm), then the strategy will display USOC_filtered_range_nominal, thereby allowing the customer to take advantage of the recovered energy to drive beyond, for example, the guaranteed 5 km. The strategy therefore makes it possible to depart from the nominal working range of the restricted battery 1 only in the cases where this is favorable for the customer.

Once the SOC USOC_filtered_customer has been calculated according to the strategy described above:

the engine torque is naturally managed so as to gradually decrease as USOC_filtered_customer approaches zero, so that power “starvation” can never occur before USOC_filtered_customer has reached zero. Indeed, it is this torque management consistent with the USOC_filtered_customer calculation that makes it possible to guarantee the last few km of driving.
the range stated to the customer, in the last few km_guaranteed, is logically made consistent with the last few km_guaranteed.

In order to validate a management method according to the invention, two examples of driving are addressed: driving with high consumption and without any regenerative phase in the last few km, and driving with a significant regenerative phase.

FIGS. 5 and 6 illustrate an example of driving with an increase in consumption in the last few km. In these two figures, it is noted that the strategy is activated as soon as the range passes below the guaranteed 5 km (km_guaranteed=5 in this example) and that the SOC displayed to the customer decreases and reaches 0% only after having driven 5 km.

FIGS. 7 and 8 illustrate an example of driving with decreased consumption in the last few km (significant recovery phases). In these two figures, it is noted that the strategy is activated as soon as the displayed range passes below the 5 km that are guaranteed and that the SOC displayed to the customer takes into account the regenerative phase and therefore the additional energy. This therefore allows, via the torque management consistent with the new calculated SOC, driving further than 5 km allowing the driver to take advantage of the recovered energy.

These examples show that the strategy makes it possible to guarantee the last few kilometers of driving while taking into account possible favorable changes in the consumption of the vehicle with respect to the range. It should be noted that this strategy works under all driving conditions, and thus allows the same performance, in terms of range over the last few km of driving, whether the weather is hot or cold, the battery is aged, the vehicle is charged, on mountain roads and for any type of driving.

It should be noted that a management method according to the invention becomes much more advantageous with a larger reserve 3. Specifically, the larger the reserve, the more it will be possible to guarantee a large number of kilometers. A number of examples of electric vehicles are present on the market which include a battery that has additional energy capacity hidden from the user, since in the case of a multiple battery (small/large capacity) offering, it may be more economical for the manufacturer to produce only a single physical object in order to avoid a larger number of parts while still providing a varied offering in terms of range (for a different customer purchase price, of course). This invention makes it possible to provide an additional benefit by intelligently exploiting this additional energy margin without additional investment on the part of the manufacturer.

1.-8. (canceled).

9. A method for managing a kilometer range of an electric traction vehicle powered by an electric battery comprising a working capacity and a reserve, the method comprising
displaying, as soon as a remaining kilometer range of the vehicle is equal to or less than a minimum number of guaranteed kilometers, a range that decreases linearly over time, regardless of driving conditions of the vehicle.

10. The management method as claimed in claim 9, wherein the kilometer range of the vehicle before the vehicle reaches the minimum number of guaranteed kilometers is determined from a state of charge of the battery by taking into account the working capacity of the battery but not the reserve, and taking into account previous driving conditions of the vehicle.

11. The management method as claimed in claim 9, wherein the displaying comprises, when the current driving conditions of the vehicle are more demanding than previous driving conditions, taking into account the working capacity and the reserve to ensure that the displayed range decreases linearly.

12. The management method as claimed in claim 9, further comprising receiving as input the following values:
USOC_battery_not_filtered corresponding to an actual physical state of charge level of the battery, expressed as a percentage of a capacity of the battery, and taking into account the working capacity and the reserve,
Margin_battery_inf corresponding to an energy reserve and equal to a difference between the working capacity and the actual capacity of the battery, expressed as a percentage of the capacity,
Range_km corresponding to a stated range displayed on a dashboard of the vehicle, expressed in kilometers,
Distance_km corresponding to a distance traveled by the vehicle, expressed in kilometers, and
Km_guaranteed corresponding to the minimum number of guaranteed kilometers.

13. The management method as claimed in claim 12, further comprising calculating the state of charge over a nominal working range of a restricted battery (USOC_filtered_range_nominal) using the formula:
$$USOC\_filtered \_range \_nominal = Max ( 0 ; \frac{USOC\_battery \_not \_filtered - margin\_battery \_inf}{100 - margin\_battery \_inf} * 100 ) .$$

14. The management method as claimed in claim 13, further comprising, prior to the displaying the range, displaying the state of charge over the nominal working range of the restricted battery as long as the stated range (Range_km) is greater than the minimum number of guaranteed kilometers (Km_guaranteed).

15. The management method as claimed in claim 12, wherein the displaying comprises calculating a virtual state of charge (USOC_xxkm), which decreases linearly with the distance traveled from when the stated range is equal to or less than the minimum number of guaranteed kilometers (Km_guaranteed).

16. The management method as claimed in claim 15, wherein the displaying comprises displaying a final state of charge (USOC_filtered_customer) given by the formula:
USOC_filtered_customer=Max (USOC_filtered_range_nominal, Min (USOC_xxkm, USOC_battery_not_filtered)
